(19) United States
(12) Patent Application Publication
(10) Pub. No.: US 2018/0349918 A1
(43) Pub. Date: Dec. 6, 2018

(54) METHOD AND APPARATUS FOR CONDUCTING ELECTRONIC COMMERCE BY USE OF INFORMATION CODE

(71) Applicant: SK Planet Co, Ltd, Seongnam-si (KR)

(72) Inventors: Ju Hyeun HAN, Yongin-si (KR); Young Seog Lee, Seoul (KR); Un Dong Chang, Gunpo-si (KR)

(73) Assignee: SK Planet Co Ltd

(21) Appl. No.: 15/991,697

(22) Filed: May 29, 2018

(30) Foreign Application Priority Data
Jun. 2, 2017 (KR) 10-2017-0069087

(51) Int. Cl. G06Q 30/00; G06Q 30/06; G06K 7/10; G06Q 10/08

(52) U.S. Cl. CPC G06Q 30/016; G06Q 30/0641; G06Q 10/0833; G06Q 10/0837; G06K 7/10861

(57) ABSTRACT

The present disclosure provides methods and apparatuses for providing electronic commerce service that may facilitate checking of the information of a delivery item and performing of an order-related process such as a completion of purchase, a return request, and an exchange request through a recognition of the information code attached on a package of the delivery item, and may allow the user to easily request the return of the delivery item by comparing an image of the actually delivered item with ordering information after the user opens the package. The present disclosure may expand the electronic commerce services and enhance user conveniences.

### CROSS-REFERENCE TO RELATED APPLICATION

This application claims priority to Korean Patent Application No. 10-2017-0069087, filed on Jun. 2, 2017, in the Korean Intellectual Property Office, which is incorporated herein in its entirety by reference.

### TECHNICAL FIELD

The present disclosure relates to a method and apparatus for providing electronic commerce service by using an information code and, more particularly, to a method and apparatus for providing electronic commerce service that may facilitate checking of the information of a delivery item and performing of an order-related process such as a completion of purchase, a return request, and an exchange request through a recognition of the information code attached on a package of the delivery item, and may allow the user to easily request the return of the delivery item by comparing an image of the actually delivered item with ordering information after the user opens the package.

### BACKGROUND

The description in this section merely provides background information of embodiments of the present disclosure and is not intended to specify prior arts of the present disclosure.

With the development of information and communication technologies, devices such as a mobile communication terminal and a personal computer are implemented to perform various functions.

The mobile communication terminal, for example, is implemented to provide various functions such as data communications, photographing a still picture or shooting a moving picture using a camera, playback of music or video contents, gaming, and broadcasting reception in addition to a traditional voice communications function.

Technology developments for expanding the functions of the mobile communication terminal are being carried out continuously in hardware aspects as well as software aspects.

Recently, in consideration of popularization and increasing performances of mobile communication terminals such as smartphones, service providers who provide their services on the Internet are producing and distributing various kinds of application programs that enable the users to use their services on the mobile terminals.

Turning to shopping or commerce services, not only Internet shopping using a personal computer (PC) but also mobile shopping using a mobile web browser or a smartphone-dedicated application program is rapidly increasing. Also, shipping and delivery services are expanding due to the development of the internet shopping and the mobile shopping.

The mobile shopping has made the use of electronic commerce service much simpler than the Internet shopping using the PC by reducing time and place constraints. Nonetheless, however, the electronic commerce still has a few drawbacks. For example, since a waybill or invoice attached on a package of the delivery item includes only the address of the recipient of the delivery item, the recipient cannot carry out an order-related procedure such as a completion of purchase for the delivery item, a return request, and an exchange request unless the recipient opens the package and checks the content of the package. Further, even if the recipient opens the package, checks the content of the package, and carries out the order-related procedure, the recipient has to log in the system through a user authentication process, choose a shopping cart or another service menu, and then carry out a required procedure, which is quite cumbersome procedurally.

On the other hand, information codes representing information in a geometric form are widely being used, and various application programs are supporting the function of recognizing such information codes. Examples of the information codes include code a simple one-dimensional barcode, a two-dimensional barcode such as a QR code, a color bar code, and any other variants of them.

Contrary to the one-dimensional barcode capable of containing only up to 20 numeric information in a series of bars, the QR code may represent up to 7,089 numeric characters, 4,296 alphanumeric characters, or 1,817 Kanji characters. Because of the large amount of data that can be represented, the QR code is widely being used both in online and offline.

The inventors are concerned with utilizing the information code to represent various information on the waybill, rather than simply printing the address and name of the recipient, in order to facilitate intuitive handling of the order and the delivery item using an application program executable in the mobile device.

In this regards, Korean Unexamined Patent Application Publication No. 2014-105931 discloses a method of automatically inputting an invoice number by photographing a code printed on an invoice of the delivery item, which is suitable for being used by a shipper or a delivery man.

### SUMMARY

Provided are methods and apparatuses for conducting electronic commerce which may enable a product purchase application program distributed by a service provider to support a function of recognizing an information code, allow a shipper to attach the information code including ordering information on a package of a delivery item, and facilitate intuitive handling of an order-related process such as a completion of purchase for the delivery item, a return request, and an exchange request through a recognition of the information code carried out by the product purchase application program and checking of the ordering information based on the information code.

Provided are methods and apparatuses for conducting electronic commerce which may facilitate repurchase of the delivery item or writing of a review for the item after a recognition of the information code in case that a recipient of the delivery item has already confirmed a purchase completion for or a receipt of the delivery item.

Provided are methods and apparatuses for conducting electronic commerce which may allow the recipient of the delivery item to request a return or exchange of the delivery item when the image of the actually delivered item acquired after opening the package is different from the ordering information corresponding to the information code.

Additional aspects will be set forth in part in the description which follows and, in part, will be apparent from the description, or may be learned by practice of the presented exemplary embodiments.

According to an aspect of an exemplary embodiment, provided is a method of conducting electronic commerce by use of an information code in a service server accessible by a device through a communications network. The method includes: receiving a recognition result of the information code for a delivery item photographed by the device to decode the information code and acquire ordering information of the delivery item according to a decoded information code; providing an order-related service notification window including the ordering information of the delivery item to the device through an application program executed in the device; receiving a service request for the delivery item through the order-related service notification window; and providing a service page corresponding to the service request in response to the service request.

The method may further include: collecting authentication base information of the device for use in authenticating whether a user of the device is a legitimate recipient of the delivery item; and authenticating the user by comparing the authentication base information with orderer information or recipient information having been received from an orderer when the orderer ordered the delivery item. In such a case, the order-related service notification window may be provided to the device when the user is authenticated in the operation of authenticating the user.

When the authentication base information is the same as the orderer information and the recipient information and the user of the device is authenticated as the legitimate recipient of the delivery item, the operation of providing the order-related service notification window may include: providing at least one of service options including a purchase completion, a return request, and an exchange request for the delivery item through the order-related service notification window, so that the user of the device chooses a desired service option. Also, the operation of receiving the service request may include: receiving information of a chosen service option through the application program.

Contrarily, when the authentication base information is different from the orderer information but is the same as the recipient information and the user of the device is authenticated as the legitimate recipient of the delivery item, the operation of providing the order-related service notification window may include: providing at least one of service options including a receipt confirmation and an exchange request for the delivery item through the order-related service notification window, so that the user of the device chooses a desired service option. In such a case, the operation of receiving the service request may include: receiving information of a chosen service option through the application program.

The method may further include: checking a current status of an order of the delivery item corresponding to the decoded information code; and, when the current status of the order shows a purchase-completed state or a receipt-confirmed state, providing the device with an alert window querying whether to repurchase the delivery item or write a review regarding the delivery item.

The method may further include: receiving an actual image of the delivery item photographed by the device; comparing the actual image with the ordering information for the delivery item corresponding to the decoded information code to determine whether the delivery item corresponds to the ordering information; and, when the delivery item does not correspond to the ordering information, querying whether to return or exchange the delivery item through a notification window in the application program executed in the device.

According to an aspect of another exemplary embodiment, provided is a method of conducting electronic commerce by use of an information code in a device capable of accessing a service server through a communications network. The method includes: photographing and decoding the information code for a delivery item according to execution of an application program; acquiring ordering information of the delivery item according to a decoded information code; authenticating whether a user of the device is a legitimate recipient of the delivery item by comparing authentication base information of the device with orderer information and recipient information; displaying an order-related service notification window including the ordering information of the delivery item corresponding to the decoded information through the application program when the user is authenticated as the legitimate recipient of the delivery item; receiving a service request for the delivery item through the order-related service notification window; and displaying a service page corresponding to the service request in response to the service request.

The method may further include: photographing the delivery item after the operation of acquiring the ordering information; comparing an image of a photographed delivery item with the ordering information for the delivery item to determine whether the delivery item corresponds to the ordering information; and, when the delivery item does not correspond to the ordering information, displaying a notification window querying whether to return or exchange the delivery item through the application program.

According to another aspect of an exemplary embodiment, a service server system for providing electronic commerce service by use of an information code includes: a service communications unit configured to transmit and receive data to and from a device through a communications network; and a service controller configured to decode the information code for a delivery item photographed by the device to acquire ordering information of the delivery item, provide an order-related service notification window including the ordering information to the device, and receiving a service request for the delivery item through the order-related service notification window; and provide a service page corresponding to a service request for the delivery item received through the order-related service notification window.

According to another aspect of another exemplary embodiment, a device for providing electronic commerce service by use of an information code includes: a communications unit configured to transmit and receive data to and from a service server through a communications network; a camera unit configured to photograph the information code and a delivery item; a storage unit configured to store an application program suitable for providing the electronic commerce service by use of the information code through an interworking with the service server; and a controller configured to acquire ordering information of the delivery item by decoding the information code, display an order-related service notification window including the ordering information through an application program, receive a service request for the delivery item through the order-related service notification window, and display a service page corresponding to the service request through the application program.

According to an aspect of yet another exemplary embodiment, provided is a non-transitory computer-readable storage medium having stored therein a program which, when executed by a processor, causes the processor to perform the method of conducting electronic commerce described above.

According to an aspect of still yet another exemplary embodiment, provided is a computer program stored in a non-transitory computer-readable storage medium which, when executed by a processor, causes the processor to perform the method of conducting electronic commerce described above.

The present disclosure may enhance user conveniences since the order-related processes such as the completion of purchase of the item, the confirmation of receipt of the delivery item, the return request, and the exchange request may be carried out through the recognition of the information code of the delivery item without a necessity for the user to log in an ordering system through a PC or to be authenticated and check the ordering information.

Also, for an item for which the purchase has been completed or the receipt has been confirmed already, since the order-related services such as the repurchase of the delivery item and the writing of the review may be attempted simply by the recognition of the information code, the repurchase of the item and the submission of the review become easier. Such an easier process of writing the review may increase an amount of the information about the delivery item that may be referenced by potential consumers, which may increase the sales of the seller and contribute to the activation of electronic commerce.

Besides, the recipient may request the return of the delivered item by photographing the actually delivered item when the delivered item is different from the ordering information even if the recipient cannot remember the ordering information or the recipient does not know the ordering information because the recipient is different from the orderer, which may enhance user conveniences and the satisfaction for the application program of the user.

The present disclosure may expand the electronic commerce industry, and is industrially applicable because it can actually be implemented obviously and has a sufficiently high possibility of commercialization or sales.

Various advantageous effects other than those described above may be disclosed explicitly or implicitly in the following descriptions of embodiments according to the present disclosure.

Further areas of applicability will become apparent from the description provided herein. It should be understood that the description and specific examples are intended for purposes of illustration only and are not intended to limit the scope of the present disclosure.

### DRAWINGS

These and/or other aspects will become apparent and more readily appreciated from the following description of the exemplary embodiments, taken in conjunction with the accompanying drawings in which:

FIG. 1 is a block diagram of a system for implementing an electronic commerce method using an information code according to an embodiment of the present disclosure;

FIG. 2 is a block diagram of a service server shown in FIG. 1 according to an embodiment of the present disclosure;

FIG. 3 is a block diagram of a device shown in FIG. 1 according to an embodiment of the present disclosure;

FIG. 4 is a message flow diagram illustrating an electronic commerce process using an information code according to an embodiment of the present disclosure;

FIG. 5 is a message flow diagram illustrating an electronic commerce process using an information code according to another embodiment of the present disclosure;

FIGS. 6 through 8 are flowcharts illustrating, in detail, an electronic commerce process using an information code according to an embodiment of the present disclosure;

FIGS. 9A through 9D are exemplary screenshots provided according to a recognition of an information code in an electronic commerce method using an information code according to an embodiment of the present disclosure; and

FIG. 10 is a block diagram illustrating an operating environment of a device for implementing an electronic commerce method using an information code according to an embodiment of the present disclosure.

The drawings described herein are for illustration purposes only and are not intended to limit the scope of the present disclosure in any way.

### DETAILED DESCRIPTION

Reference will now be made in detail to exemplary embodiments, examples of which are illustrated in the accompanying drawings, wherein like reference numerals refer to like elements throughout.

In the following description and the accompanied drawings, detailed descriptions of well-known functions or configuration that may obscure the subject matter of the present disclosure will be omitted for simplicity. It is to be noted that the same components are designated by the same reference numerals throughout the drawings.

The terms and words used in the following description and drawings are not necessarily to be construed in an ordinary sense or a dictionary, and may be appropriately defined herein to be used as terms for describing the present disclosure in the best way possible. Such terms and words should be construed as meaning and concept consistent with the technical idea of the present disclosure.

The configurations of embodiments described in this specification or shown in the drawings are merely the most preferred embodiments of the present disclosure, and do not limit the technical ideas of the present disclosure. Therefore, it should be understood that there are various equivalents and modifications that may replace the configurations of the embodiments.

The terminologies including ordinals such as “first” and “second” used to explain various elements in this specification may be used to discriminate an element from the other ones or for simplicity. For example, a second component may be referred to as a first component, and similarly, a first component may also be referred to as a second component without departing from the scope of the present disclosure.

When an element is referred to as being “connected” or “coupled” to another element, it means that it is logically or physically connected or it may be connected to the other element. In other words, it is to be understood that although an element may be directly connected or coupled to another element, there may be other elements therebetween, or element may be indirectly connected or coupled to the other element.

The terminology used herein is for the purpose of describing particular embodiments only and is not intended to be limiting of the disclosure. The singular forms include plural referents unless the context clearly dictates otherwise.

Also, The expressions “˜comprises,” “˜includes,” “˜constructed,” “˜configured” are not to be construed as being equipped with all the components, processing steps, or operations described in this specification, but some of the components, the processing steps, or the operations may not be included and additional elements may be incorporated further.

Terminologies such as “˜unit” and “˜module” refer to entities performing at least one function or operation, and may be implemented by hardware, software, or combination thereof.

The articles ‘a,’ ‘an,’ ‘the,’ ‘one,’ and their equivalents may be used in the sense of including both the singular and the plural meaning unless the context clearly indicates otherwise or is clearly contradicted by context in the context of describing the disclosure, particularly, in the context of the following claims.

According to an embodiment of the present disclosure, the information code may be a QR code. However, the present disclosure is not limited thereto, and any information code that may accommodate lots of information and is commercially available or will be available in the future may be used as well regardless of a type of the code such as one-dimensional, two-dimensional, and three-dimensional codes.

Now, described are an electronic commerce method using an information code according to an embodiment of the present disclosure and a system for implementing the method.

FIG. 1 is a block diagram of the system for implementing the electronic commerce method using the information code according to an embodiment of the present disclosure.

Referring to FIG. 1, the system for implementing the electronic commerce method using the information code according to an embodiment of the present disclosure (hereinbelow, referred to as “electronic commerce system”) includes a device 100 and a service server 200 that may be connected to the device 100 through a communications network 300.

The device 100 is a user equipment that executes a product purchase application program (hereinbelow, referred to as “application program”) distributed by the service server 200 to photograph an information code of a delivery item and request an ordering service processing according to ordering information for the delivery item corresponding to the information code.

The service server 200 is operated by a service provider of an electronic commerce service such as an online shopping mall constructed by a seller, an open market service of mediating transactions between sellers and consumers, and a social commerce service allowing collaborative purchases based on the communications network 300. The service server 200 may distribute the application program suitable for use in the electronic commerce service.

The application program may be a product purchasing application which may perform a product purchasing process.

The service server 200 may generate the information code containing information about a product ordered by an orderer, so that the information code is delivered to a recipient along with the product. For example, the information code may be provided to a sender or shipper of the delivery item, so that the sender or shipper may print the information code and attach on a package of the delivery item.

The application program according to the present disclosure may be downloaded from a server, such as an application store server (not shown), that mediates downloading of applications between the device 100 and the service server 200. The service server 200 may register the application program to the application store server, so that the device 100 may connect to the application store server and download the application program.

Each of the device 100 and the service server 200 is mounted with at least one processor, which may execute program instructions for performing the method according to the present disclosure. The processor may be a single-threaded processor. Alternatively, however, the processor may be a multithreaded processor. The program instructions executed by the processor may be stored on a memory or a storage device.

In detail, the device 100 according to the present embodiment may access the communications network 300 to request the service server 200 to decode the information code and to proceed an order-related service such as a purchase completion, a receipt confirmation, a return, and an exchange for an order related to the decoded information code.

The device 100 may execute the application program (i.e., the product purchasing application the according to the present disclosure) having been distributed by the service server 200 and downloaded from the application store server.

According to an embodiment of the present disclosure, a user may receive the product purchasing services from the service server 200 by executing the application program in the device 100 rather than by accessing web pages provided by the electronic commerce system.

The device 100, which transmits and receives data through the communications network 300 according to key inputs of the user, may be a smartphone. However, the present disclosure is not limited thereto, and any portable device capable of carrying out receiving voice, communications, and photographing may be used as the device 100.

For example, the device 100 may be any one of a tablet PC, a laptop computer, a personal digital assistant (PDA), a mobile communication terminal, and the like. Besides, any devices having communications and photographing capabilities that are commercially available or may be developed in the future may be used as the device 100.

Also, the device 100 may perform voice or data communications through the communications network 300, and may include a browser for transmitting and receiving information, a memory for storing programs and protocols, and a microprocessor for executing programs for calculation and control purposes.

The service server 200 may distribute the application program facilitating the ordering and shipment of goods. Also, service server 200 may generate the information code containing the ordering information of an ordered item so as to deliver to the recipient along with the ordered item.

The information code may be a QR code. However, the present disclosure is not limited thereto, and any information code that may accommodate lots of information and is commercially available or will be available in the future may be used as well regardless of a type of the code such as one-dimensional, two-dimensional, and three-dimensional codes.

The information code may be attached on the package of the delivery item so that ordering-related processes may be performed by the application program only by recognizing the information code although the user does not open the package.

The service server 200 may receive the recognition result for the photographed information code for the delivery item from the device 100 to decode the information code for the delivery item. The recognition result may be an image itself of the photographed information code, or may be a variation thereof acquired by performing an image processing for the photographed information code in the device 100 to ease the transmission to the service server 200.

The service server 200 may provide the device 100 with an order-related service notification window including the ordering information for the delivery item corresponding to the information code through the application program executed in the device 100. The service server 200 may receive a service request of the user for the delivery item through the order-related service notification window. In response to the service request, the service server 200 may provide device 100 with a corresponding service page.

Thus, the user, who may be the recipient of the delivery item, may receive the service page from the service server 200 by running the application program, photographing the information code, and choosing a service request corresponding to the service page in the order-related service notification window, instead of performing a user authentication procedure including logging-in operation, finding ordering information by checking an order list or shopping cart, and then requesting the order-related service.

Meanwhile, the service server 200 may perform a process of checking whether the user of the device 100 is a legitimate recipient of the delivery item in consideration that the user of the device 100 may not be the legitimate recipient of the delivery item. Accordingly, a person who is not the legitimate recipient such as a delivery man and a temporary custodian cannot request the service server 200 to check ordering information or to provide the order-related service such as the purchase completion, the receipt confirmation, the return, and the exchange.

For this purpose, the service server 200 may acquire identification information (e.g., telephone number) of the device 100 and compare the acquired identification information with information of the orderer or recipient having been input by the orderer when placing the order. If the acquired identification information is identical with the information of the orderer or recipient, the service server 200 may determine that the user of the device 100 is the legitimate recipient of the delivery item and perform a series of processes to provide the device 100 with the order-related service notification window. In other words, the service server 200 may authenticate the user of the device 100 by using the information of the device 100 instead of making the user of the device 100 to input an ID and password.

The decoding of the information code and the authentication of the user of the service server 200 may be carried out in the device 100 rather than the service server 200.

On the other hand, the communications network 300 allows the device 100 and the service server 200 transmits and receive data to and from each other for transferring or exchanging various information.

The communications network 300 may be a wireless network adopting a wireless communication scheme such as wireless local area network (WLAN), Wi-Fi, wireless broadband Internet (Wibro), Worldwide Interoperability for Microwave Access (WiMAX), and High Speed Downlink Packet Access (HSDPA). However, the present disclosure is not limited thereto, but the communications network 300 may be a wired network adopting a communication scheme such as Ethernet, Digital Subscriber Line (xDSL) such as Asymmetric Digital Subscriber Line (ADSL) and Very High Bitrate Digital Subscriber Line (VDSL), Hybrid Fiber Coaxial Cable (HFC), Fiber-to-the-Curb (FTTC), and fiber-to-the-home (FTTH).

However, the present disclosure is not limited thereto, but the communications network 300 may be implemented based on another communication scheme that is already available or may be developed in the future.

According to the present disclosure, the user of the device 100 may photograph the information code attached on the package of the delivery item to request the order-related service such as the purchase completion, the receipt confirmation, the return, the exchange, a repurchase, and writing a review for the delivery item associated with the decoded information code from the service server 200 as described above.

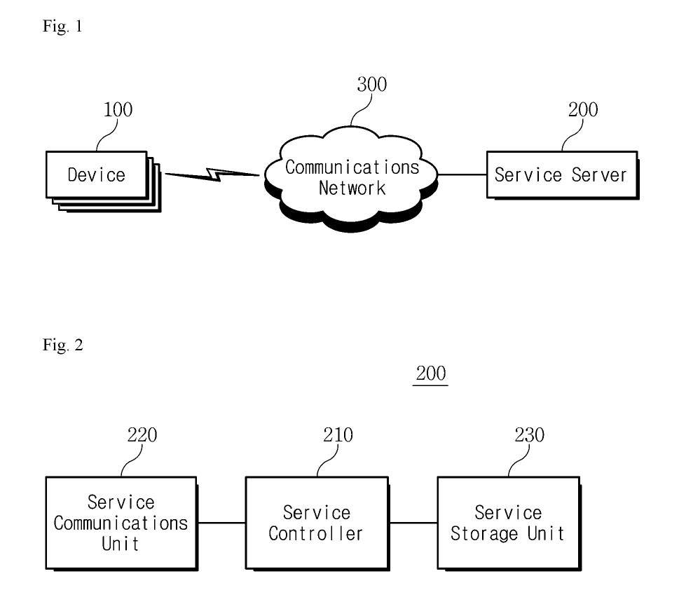

The electronic commerce method using the information code according to an embodiment of the present disclosure will now be described in more detail with reference to FIGS. 2 through 9.

FIG. 2 is a block diagram of the service server 200 according to an embodiment of the present disclosure.

Referring to FIG. 2, the service server 200 according to an embodiment of the present disclosure includes a service controller 210, service communications unit 220, and a service storage unit 230.

The service communications unit 220 communicates with the device 100 through the communications network 300 to exchange data for processing the electronic commerce service.

The service storage unit 230 stores all the programs required for decoding the recognition result for the photographed information code received from the device 100 and providing the order-related services.

In particular, the service storage unit 230 may store the ordering information including the orderer and recipient information for the item ordered by the orderer.

The service controller 210 may be a processor which executes an operating system and each configuration of the service server 200.

The service controller 210 controls overall operations of the service server 200 including the decoding of the recognition result for the photographed information code received from the device 100 and the responding to the service request for the delivery item from the device 100.

According to the present embodiment, the service controller 210 may receive the recognition result for the photographed information code from the device 100, and decodes the recognition result for the photographed information code to obtain the ordering information for the delivery item.

The information code may be attached on the package of the delivery item so as to allow the user to request the order-related services without opening the package of the delivery item. The information code may be the QR code. However, the present disclosure is not limited thereto, and any information code that may accommodate information may be used as the information code.

The service controller 210 may provide the device 100 with an order-related service notification window including the ordering information for the delivery item through the application program executed in the device 100.

The ordering information, which is information about the delivery item ordered by the orderer, may include product information such as a product name, a brand, an ordered quantity, and other ordering options, the orderer information such as a name and a telephone number of the orderer information, and the recipient information such as a name, a telephone number, and an address of the recipient.

The order-related service notification window allows the user of the device 100 who may be the recipient of the delivery item to choose a desired service and may be displayed on the device 100 in a form of a pop-up window, for example.

Meanwhile, the service controller 210 may authenticate the user of the device 100, so that any person who is not the legitimate recipient for the delivery item on which the information code is attached cannot request the service server 200 to check the ordering information or to provide the order-related services.

Here, the service server 200 may collect the identification information (e.g., the phone number) of the device 100 and compare the collected identification information with the information of the orderer or the recipient having been input by the orderer when placing the order. If the collected identification information is identical with the information of the orderer or recipient, the service server 200 may determine that the user of the device 100 is the legitimate recipient of the delivery item and perform a series of processes to provide the device 100 with the order-related service notification window.

For example, in case that the user of the device 100, the orderer, and the recipient are all the same, the delivery item is deemed to have been delivered normally to the recipient. In this case, the order-related service notification window may include service options of ‘COMPLETE PURCHASE,’ ‘RETURN,’ and ‘EXCHANGE.’ The user of the device 100 may send the service request to the service controller 210 of the service server 200 by choosing one desired service option in the service menu shown in the order-related service notification window.

The service controller 210 may provide the application program being executed in the device 100 with a service page corresponding to the service request from the device 100.

If the service request from the device 100 is the ‘COMPLETE PURCHASE,’ the service controller 210 may change the status of the order into a ‘purchase-completed’ state and store the changed state. If the service requested by the device 100 is ‘RETURN,’ the service controller 210 provides the device 100 with a page for requesting the return of the delivered item. If the service requested by the device 100 is ‘EXCHANGE,’ the service controller 210 provides the device 100 with a page for requesting the exchange of the delivered item. Thus, the user of the device 100 who is also the orderer and the recipient may request service such as the purchase completion, and the refund or the exchange of the delivery item and receive the service page corresponding to the requested service only by running the application program and photographing the information code regardless of the opening of the package.

On the other hand, in case that the orderer is different from the recipient but the user of the device 100 is the same as the recipient, the delivery item may also be deemed to have been delivered normally to the recipient because the recipient can be regarded as having been designated by the orderer. In this case, the order-related service notification window may include service options of the ‘CONFIRM RECEIPT’ and ‘EXCHANGE.’ The user of the device 100 may send the service request to the service controller 210 of the service server 200 by choosing the desired service option in the service menu shown in the order-related service notification window.

The refund request, however, may not be available in this case since personal information such as payment information of the orderer may be required, and only the exchange menu for changing the color, size, and other options for the same product may be provided in the service menu.

If the service request from the device 100 is the receipt confirmation, the service controller 210 may change the status of the order into a ‘receipt-confirmed’ state and stores the changed state. At this time, the service server 200 may notify the orderer, by a short message service (SMS), e-mail, instant messenger, or the like, that the recipient has confirmed the receipt of the delivery item. If the service requested by the device 100 is ‘EXCHANGE,’ the service controller 210 may provide the device 100 with a page for requesting the exchange of the delivered item.

Meanwhile, it may be possible that the user of the device 100 who is the recipient has already opened the package of the delivery item and confirmed purchase completion for the delivery item or confirmed the receipt of the delivery item through the application program or a common web service.

Thus, the service controller 210 may check a current status of the order for the delivery item when acquiring the ordering information through the information code. If the status of the order of the delivery item is the purchase-completed state or the receipt-confirmed state, the service controller 210 may provide the device 100 with an alert window querying whether to repurchase the delivered item or write a review for the item instead of the order-related service notification window.

Here, when the user of the device 100 being the same as both the orderer and the recipient chooses to repurchase an item, the service controller 210 may provide the device 100 with a payment page, as the service page, for the user to pay the price for repurchasing the item corresponding to the information code.

When the user of the device 100 who is different from the orderer but the same as the recipient chooses to repurchase an item, the service controller 210 may provide the device 100 with an ordering page, as the service page, including seller information and product information of the delivered item.

If the user of the device 100 chooses to write a review for the delivered item, the service controller 210 may provide the device 100 with a review writing page through the application program.

Thus, when the user of the device 100 who is the legitimate recipient wishes to repurchase the delivery item or write the review for the delivery item after confirming purchase completion for the item or confirming the receipt of the item, the user can directly receive the payment page, the ordering page, or the review writing page through the application program without any searching or relevant processes. Thus, the present disclosure may activate the repurchase of products and the providing of product information through product reviews.

On the other hand, the return or exchange request may be placed based on a comparison of the item actually delivered to the user with the item in the ordering information. The service controller 210 may compare information of an actually delivered item acquired after the user opens the package with the information of the ordered item in the ordering information. If the information of the delivered item is different from the information of the ordered item, the service controller 210 may query the user for the return or exchange request through the notification window on the application program being executed in the device 100.

In more detail, the service controller 210 may receive the image of the actually delivered item photographed by the device 100 and analyze the received image to check the information of the item actually delivered to the user of the device 100. The image analysis may be carried out in various ways. For example, the service controller 210 may extract markers included in the item image and extract some portion of the item image based on the markers.

The service controller 210 determines whether the item actually delivered to the user is the same as the item in the ordering information by comparing the product information extracted from the received image with the information of the item corresponding to the information code. If it is determined that the delivered item actually delivered to the user is not the same as the item in the ordering information, the service controller 210 may provide the notification window for receiving the service request.

For example, in case that the user of the device 100 who is the recipient of the delivered item is the same as the orderer, the service controller 210 may provide the notification window including service options of querying whether to return or exchange the delivered item and complete the purchase of the item. Contrarily, in case that the user of the device 100 who is the recipient of the delivered item is not the same as the orderer, the service controller 210 may provide the notification window including service options of querying whether to exchange the delivered item and confirm the receipt of the item.

As described above, the return or exchange request may be placed through the order-related service notification window based on the information code acquired by decoding the photographed information code regardless of the opening of the package, as well as based on a comparison of the item actually delivered to the user with the item in the ordering information after photographing the information code and analyzing the photographed image.

There may be cases where the recipient is different from the orderer and the recipient cannot know whether the delivery item is the product ordered by the orderer, or where the recipient being the same as the orderer cannot remember the ordering information. Conventionally, in such cases, the recipient had to contact the orderer or log in the commerce system to check the ordered item registered in the ordering information.

The present disclosure, however, allows the user to immediately check whether the delivery item is the ordered product by simply photographing the information code and the delivery item after opening the package of the delivery item and to place the return or exchange request, which may enhance the satisfaction of the user for the service.

Although the present specification and drawings describe exemplary device configurations, the functional operations and subject matters described herein may be implemented in other types of digital electronic circuitry, or may be formed computer software, firmware, or hardware including structures and structural equivalents thereof, and/or a combination of the hardware component and the software component. The subject matter described herein may be implemented by one or more computer program products, in other words, one or more modules of computer program instruction encoded in a intangible computer-readable program storage medium for controlling the operation of the device according to the present disclosure. The computer-readable medium may be a machine-readable storage device, a machine-readable storage substrate, a memory device, a composition of matter that affects the machine readable propagation-type signal, or a combination of one or more of the devices or the matter.

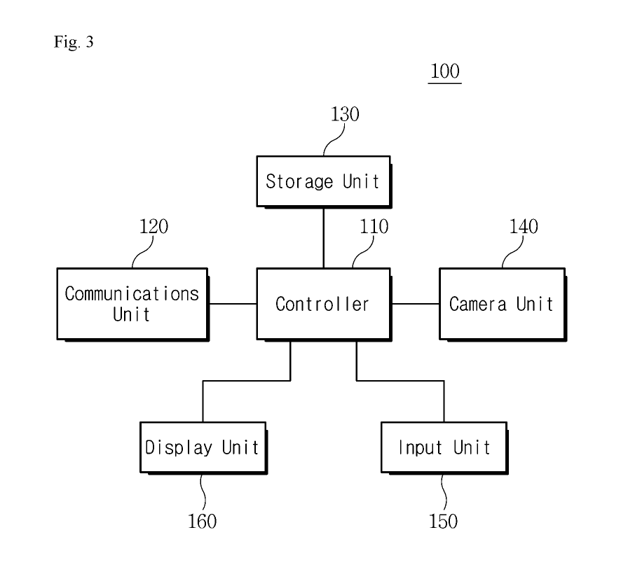

FIG. 3 is a block diagram of the device 100 according to an embodiment of the present disclosure.

Referring to FIG. 3, the device 100 according to an embodiment of the present disclosure may include a controller 110, a communications unit 120, a storage unit 130, a camera unit 140, an input unit 150, and a display unit 160. Here, the storage unit 130 may store

The storage unit 130 may store the product purchase application program which is distributed by the service server 200 and downloaded from the application store server (not shown).

The controller 110 may be a processor executing an operating system (OS) and executable programs implementing at least some of the configurations of device 100.

In particular, the controller 110 controls overall operations of the device 100 and, in particular, controls the operations related to the electronic commerce service provided by the service server 200 to the user of to the device 100.

Specifically, the controller 110 may controls the transmission of the recognition result for the photographed information code from the device 100 to the service server 200. After the service server 200 acquires the ordering information by decoding the information code or authenticates the legitimate recipient, the controller 110 may display the order-related service notification window received from the service server 200 through the display unit 160. The controller 110 may transmit the information of the chosen service determined in response to an input of the user of the device 100, and receive the corresponding service page from the service server 200 to display through the display unit 160.

Also, the controller 110 may control the operation of transmitting the image of the delivered item after the user opens the package of the delivered item. After the service server 200 analyzes the image of the actually delivered item and compares the product information extracted from the image of the actually delivered item with the information of the item corresponding to the information code, the controller 110 may control the operation of displaying the notification window querying whether to return or exchange the delivered item or confirm the receipt of the item through the display unit 160.

In other words, according to an embodiment, the controller 110 may control the operation of photographing the information code and transmitting the photographed images to the service server 200, and the operation of displaying the notification window and the service pages through the display unit 160.

According to another embodiment, the controller 110 may perform the decoding of the information code, the authentication of the legitimate recipient, and the analysis of the photographed image of the actually delivered item in addition to photographing the information code and displaying the notification window and the service pages. In such a case, the device 100 may collect the orderer information or the recipient information in the ordering information from the service server 200 for the authentication of the legitimate recipient. Also, the device 100 may compare the orderer information or the recipient information in the ordering information with the authentication base information (e.g., the telephone number) of the user of the device 100 to perform the authentication of the legitimate recipient.

Also, the controller 110 may analyze the image of the delivered item by an image analysis algorithm utilizing the marker, for example, to extract the product information and compare the product information with the information of the item corresponding to the information code to determine whether the delivered item is identical to the ordered item.

In other words, according to another embodiment, the controller 110 may control the operations of photographing the information code or the actually delivered item, analyzing the photographed image, authenticating the legitimate recipient, and displaying the order-related service notification window through the display unit 160. Upon receiving the user input of choosing a service such as the purchase completion, the return, or the exchange, the controller 110 may transmit the service request for the chosen service to the service server 200, and then receive the corresponding service page from the service server 200 to display through the display unit 160. In this case, the service server 200 provides the service page corresponding to the service request from the device 100 and performs relevant processes, but may not perform the decoding the information code, the authentication of the legitimate recipient, or the analysis of the product image.

The communications unit 120 communicates with the service server 200 through the communications network 300 to transmit data for providing the electronic commerce service according to the present disclosure such as the recognition result of the photographed information code, the decoded or analyzed information, or the order-related service request to the service server 200.

The communications unit 120 may include at least one of a wireless communication module (not shown) and a wired communication module (not shown).

The wireless communication module, which enables the data transmission through the network adopting the wireless communication scheme, may include at least one of a mobile communication module, a wireless LAN communication module, and a wireless personal area network (PAN).

The wired communication module, which enables the data transmission through a wired channel, may access the communications network 300 through the wired channel to transmit data to the service server 200.

The storage unit 130, which is a device for storing data, includes a main memory device and an auxiliary storage device and stores an application program required for the functional operation of the device 100 and data necessary for the running of the program The storage unit 130 may include a program area and a data area 130.

In particular, the storage unit 130 according to the present disclosure may store the product purchase application program which is distributed by the service server 200 and downloaded from the application store server. Also, the storage unit 130 may store a code decoding program for decoding the information code and an image analysis program for analyzing the product image.

The camera unit 140 photographs the information code or the actually delivered item. The camera unit 140 may be a camera provided in a front face or rear face of the device 100. The photographed image of the information code or the actually delivered item may be transmitted to the service server 200 which decodes or analyzes the photographed image.

The input unit 150 receives the user input and transfers the input signal associated with a function setting or a function control of the device 100 to the controller 110 or the service server 200.

The input unit 150 may include at least one of a keypad and a touchpad that generates an input signal according to a touch or manipulation of the user. The input unit 150 and 150 and the display unit 160 may be incorporated into a single touch panel screen that may perform both the input and display functions.

Any other type of input device that may be developed and available in the future in addition to a conventional input device such as a keyboard, the keypad, a mouse, a joystick, and the like may be used as the input unit 150.

The display unit 160 may display information of a series of operating states and operation results during the operation of the device 100. Also, the display unit 160 may display a menu of the device 100 and the data input by the user.

The display unit 160 may a liquid crystal display (LCD), a thin film transistor LCD (TFT-LCD), a light emitting diode (LED), an organic light emitting diode (OLED), an active-matrix organic light emitting diode (AMOLED), a retina display, a flexible display, or a three-dimensional display.

When the display unit 160 is implemented in a form of the touch screen, the display unit 160 may perform some or all of the functions of the input unit 150.

In more detail, the display unit 160 may display an user interface screen provided by the product purchase application program, the order-related service notification window, and the service pages received from the service server 200 according to the choice of the user of the device 100.

If the status of the order for the delivery item is the purchase-completed state or the receipt-confirmed state, the display unit 160 may display the alert window for querying the user whether to repurchase the delivered item or write the review for the item. Also, the display unit 160 may display the payment page, the ordering page, or the review entry page depending on the choice of the user of the device 100.

When the delivery item is different from the ordered item, the display unit 160 may display the notification window for querying the user for to return or exchange the delivered item.

For example, in case that the device 100 is a smartphone equipped with a touch panel screen, after the user starts the product purchase application program and photographs the information code through the camera unit 140 by manipulating the product purchase application program, the controller 110 of the device 100 or the service controller 210 of the service server 200 decodes the information code. Afterwards, the order-related service notification window including the ordering information of the delivery item corresponding to the information code may be displayed on the display unit 160 so as to enable the user to request one of the order-related services. In the case that the orderer is the recipient, the order-related service notification window may include service options configured to allow the user to choose one of the services of the purchase completion, the return, and the exchange of the delivery item. If the user touches one of the service options, the service request corresponding to the touched service option is transmitted to the service server 200 and the service page corresponding to the service request is transmitted to the device 100 to be displayed on the display unit 160.

For instance, when the service request for the return of the delivery item is transmitted to the service server 200, and a return request entry page may be transmitted by the service server 200 to the device 100 and displayed on the display unit 160.

As described above, the device 100 according to an embodiment of the present disclosure may execute the product purchase application program downloaded from the application store server and photograph the information code or the delivered item through the camera unit 140, and exchange data with the service server 200 based on the photographed information code or the photographed item actually delivered to the user so as to facilitate the purchase completion, the receipt confirmation, the return request, the exchange request, and the repurchase of the delivery item, and writing the review of the user.

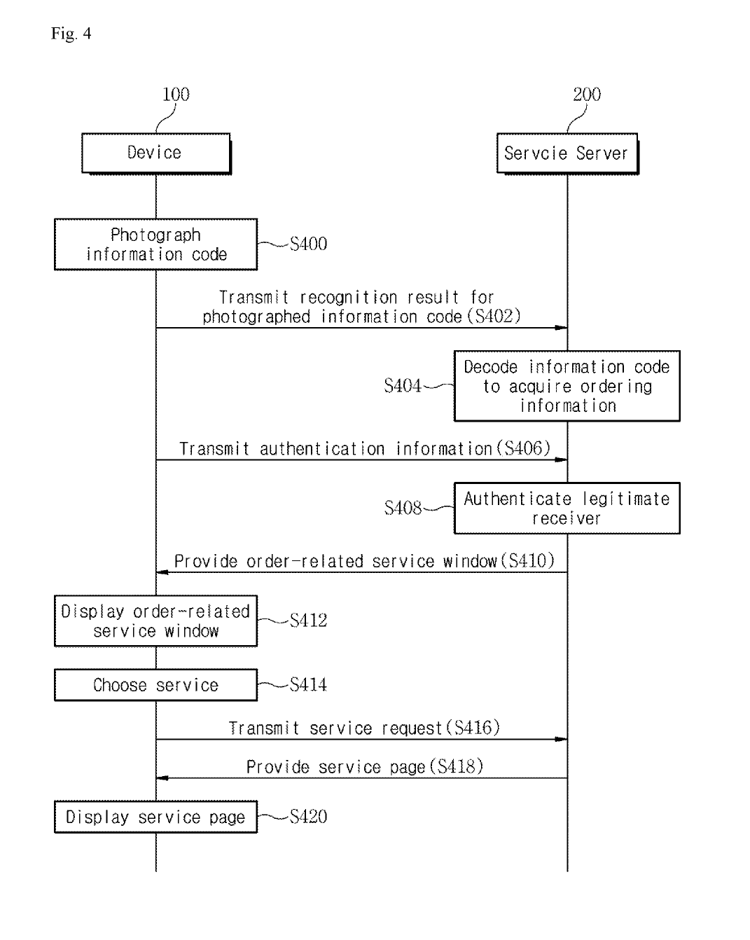

FIG. 4 is a message flow diagram illustrating an electronic commerce process using the information code according to an embodiment of the present disclosure.

In the embodiment shown in FIG. 4, the operations of photographing the information code, displaying the information through the display unit 160, and receiving a service choice input from the user are carried out by the device 100, and the operations of decoding the information code and authenticating the legitimate recipient or analyzing the image of the actually delivered item are performed by the service server 200. In particular, the operations of photographing the information code and authenticating the legitimate recipient are emphasized in FIG. 4.

After photographing the information code (S400), the device 100 may transmit the recognition result for the photographed information code such as the image itself of the photographed information code or a variation thereof to the service server 200 (S402). The service server 200 decodes the information code by using the code decoding program to acquire the ordering information according to the decoded information code (S404). The ordering information may include the orderer information, the recipient information, and various information about the ordered item.

The service server 200 may collect the authentication base information of the user such as the telephone number of the device 100 to determine whether the user who has photographed the information code using the device 100 is the legitimate recipient of the delivery item (S406). The service server 200 may perform the authentication of the recipient of the delivery item by comparing the collected authentication base information of the user with the orderer information or the recipient information corresponding to the information code (S408).

After the authentication is completed successfully, the service server 200 provides the device 100 with the order-related service notification window (S410) so that the order-related service notification window is displayed in the device 100 through the product purchase application program (S412). Here, the service options that may be included in the order-related service notification window may differ depending on whether the user of the device 100 is the orderer of the item or a separate recipient designated by the orderer. The device 100 may receive the service choice input, from the user, choosing a service among the service options included in the order-related service notification window (S414), and transmit the service request corresponding to the choice of the user to the service server 200 (S416).

The service server 200 provides the device 100 with the service page corresponding to the service request (S418), and the device 100 displays the service page through the product purchase application program (S420).

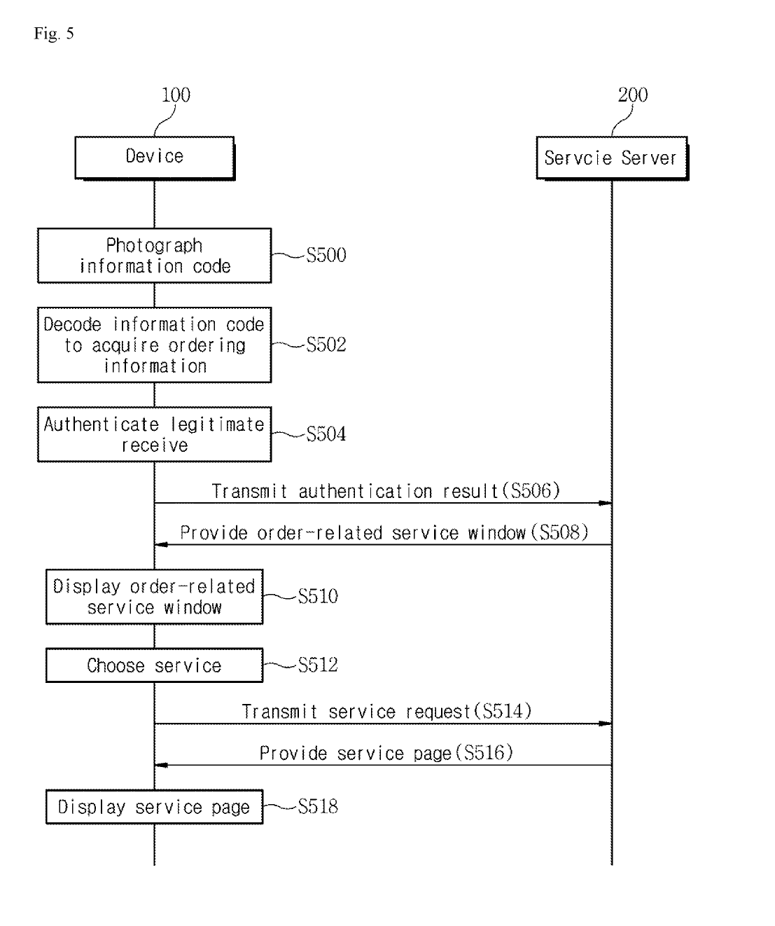

FIG. 5 is a message flow diagram illustrating the electronic commerce process using the information code according to another embodiment of the present disclosure.

In the embodiment shown in FIG. 5, the device 100 may carry out the operations of decoding the information code, authenticating the legitimate recipient, and analyzing the image of the actually delivered item in addition to photographing the information code, displaying the order-related service notification window, and receiving a service choice input from the user. The service server 200 may provide the service pages in response to the service request from the device 100. In FIG. 5, the operations of photographing the information code and authenticating the legitimate recipient are emphasized similarly to FIG. 4.

After the device 100 photographs the information code (S500), the device 100, rather than the service server 200, may decode the information code by using a code decoding program to acquire the ordering information according to the decoded information code (S502).

At this time, in order that the order-related service notification window may be displayed only for the legitimate recipient, the device 100 may authenticate the user by comparing the authentication base information of the user with the orderer information or the recipient information which has been input by the orderer when ordering the item (S504). The device 100 may acquire the orderer information or the recipient information directly from the information code, or may receive such information from the service server 200 by providing the information code to the service server 200.

The device 100 may transmit the authentication result to the service server 200 (S506). In case that the user is authenticated as the legitimate recipient, the service server 200 provides the device 100 with the order-related service notification window (S508) so that the order-related service notification window is displayed in the device 100 through the product purchase application program (S510). Here, the service options that may be included in the order-related service notification window may differ depending on the recipient of the delivery item.

The device 100 may receive the service choice input, from the user, choosing a service among the service options included in the order-related service notification window (S512), and transmit the service request corresponding to the choice of the user to the service server 200 (S514). The service server 200 provides the device 100 with the service page corresponding to the service request (S516), and the device 100 displays the service page through the product purchase application program (S518).

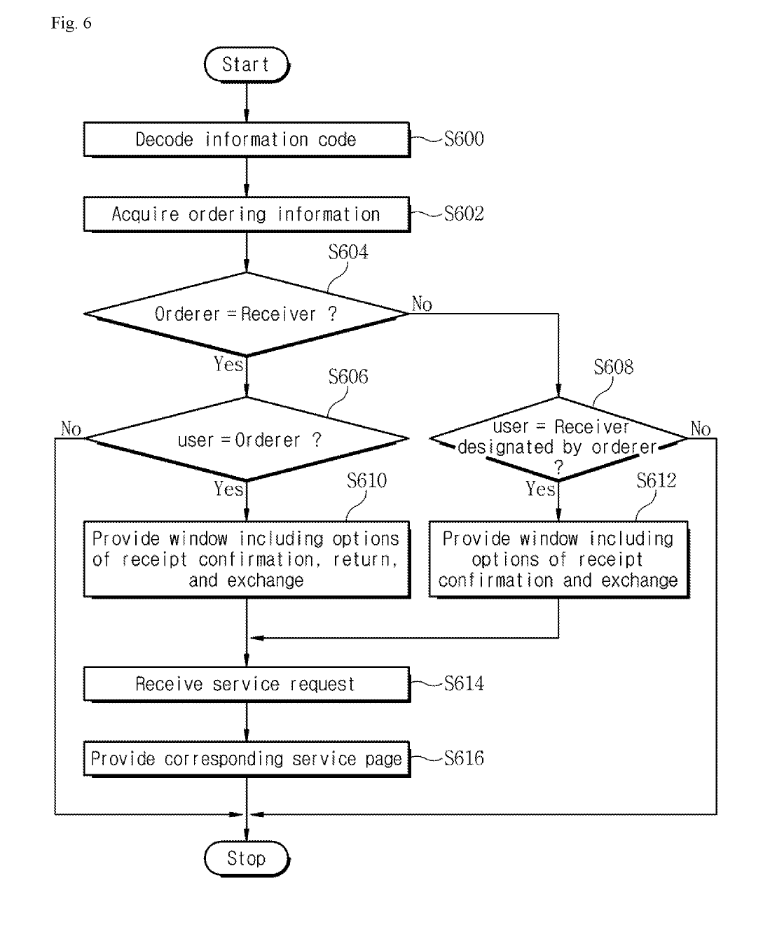

FIGS. 6 through 8 are flowcharts illustrating, in detail, the electronic commerce process using the information code according to an embodiment of the present disclosure.

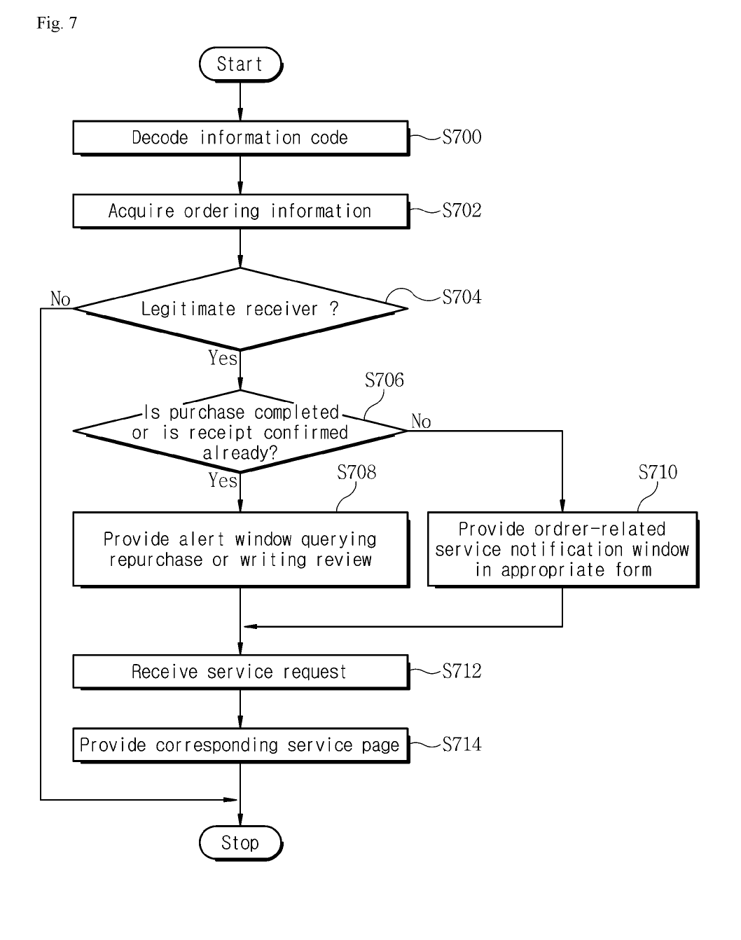

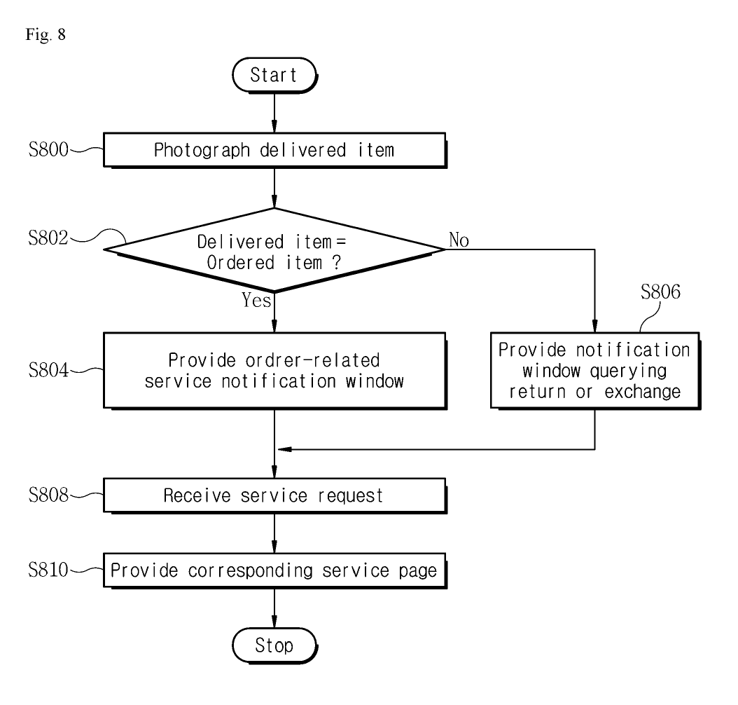

FIG. 6 shows an embodiment in which the order-related service notification window is provided after the decoding of the information code and the authentication of the legitimate recipient, FIG. 7 shows an embodiment in case where the status of the order for the delivery item corresponding to the information code is a purchase-completed state or a receipt-confirmed state, and FIG. 8 show an embodiment in which the actually delivered item is photographed by the device 100.

Referring to FIG. 6, the user of the device 100 starts the product purchase application program and photographs the information code through the camera unit 140. Subsequently, the device 100 or the service server 200 decodes the information code to acquire the ordering information corresponding to the information code (S600, S602). Before the order-related service notification window is provided in the device 100, a process of authenticating the legitimate recipient is performed so that only the legitimate recipient can request services in operations S604 through S608.

The authentication may be carried out by comparing the authentication base information of the user such as the telephone number of the device 100 with the orderer information or the recipient information which has been input by the orderer when ordering the item. Here, the ordering information including the orderer and the recipient may be identified based on the information code. The authentication may be carried out by the service server 200, but may be performed by the device 100 as well.

In detail, in case that the orderer information is the same as the recipient information (S604) and the authentication base information of the user of the device 100 is the same as the orderer information or the recipient information (S606), the user of the device 100 may be determined as the legitimate recipient. Meanwhile, in case that the orderer information is different from the recipient information (S604) but the authentication base information of the user of the device 100 is the same as the recipient information having been input by the orderer (S606), the user of the device 100 may be the recipient designated by the orderer and may be determined to be the legitimate recipient

If the user of the device 100 is not the legitimate recipient, the service request of the user is not processed normally and the user cannot receive a desired service. However, if the user is determined to be the legitimate recipient, the device 100 may receive the order-related service notification window (S610, S612).

In case that the user of the device 100 is the orderer, the order-related service notification window including the service options of the purchase completion, the return request, and the exchange request may be provided to the device 100 (S610). In case that the user of the device 100 is a separate recipient designated by the orderer, the order-related service notification window including the service options of the receipt confirmation and the exchange request may be provided to the device 100 (S612).

The user of the device 100 may choose one of the service options the order-related service notification window. In response to the user input choosing the service option, the service request may be transmitted to the service server 200. Upon receiving the service request (S614), the service server 200 may provide the device 100 with the service page corresponding to the service request (S616).

In other words, in case that the user of the device 100 is the orderer, the order-related service notification window including the service options of the purchase completion, the return request, and the exchange request may be provided to the device 100 so that the user may choose a desired service by choosing corresponding one of the service options. If the service request from the device 100 is the purchase completion, the service server 200 may change the status of the order into the ‘purchase-completed’ state. If the service requested by the device 100 is the return or the exchange, the service server 200 may provide the device 100 with the service page for requesting the return or the exchange of the delivered item.

Meanwhile, in case that the user of the device 100 is a separate recipient designated by the orderer, the order-related service notification window including the service options of the receipt confirmation and the exchange request may be provided to the device 100. If the service request from the device 100 is the receipt confirmation, the service server 200 may change the status of the order into the ‘receipt-confirmed’ state. If the service requested by the device 100 is the exchange, the service server 200 may provide the device 100 with the service page for requesting the exchange of the delivered item.

Referring FIG. 7, the operations S700 and S702 of photographing and decoding the information code are the same as the operations S600 and S602 in FIG. 6. Also, the operation S704 of authenticating the user is similar to the operations S604 through S608 in FIG. 6.

If the current status of the order for the delivery item corresponding to the information code shows the ‘purchase-completed’ or ‘receipt-confirmed’ state (S706), the service server 200 may provide the device 100 with the alert window querying whether to repurchase the delivered item or write the review for the item (S708) instead of the order-related service notification window.

Assuming that the user of the device 100 is the orderer and the status of the order is the ‘purchase-completed’ state, when the user of the device 100 chooses to repurchase the item, the service server 200 may provide the payment page for the same item in response to the service request for the repurchase (S712, S714).

Assuming that the user of the device 100 is a separate recipient designated by the orderer and the status of the order is the ‘receipt-confirmed’ state, when the user of the device 100 chooses to repurchase the item, the service server 200 may provide the ordering page including the product information and the seller information for the delivered item in response to the service request for the repurchase (S712, S714).

Meanwhile, when the user of the device 100 chooses to write the review, the service server 200 may provide a page for writing and submitting the review of the product.

On the other hand, if the current status of the order for the delivery item corresponding to the information code is not the ‘purchase-completed’ state or the ‘receipt-confirmed’ state yet (S706), the service server 200 may provide the device 100 with the order-related service notification window in an appropriate form as described above with reference to FIG. 6 and provide services according to the service choice of the user (S708-S714).

Thus, the user of the device 100, who is the recipient of the delivered item, may repurchase the item, for which the purchase has been completed or the receipt has been confirmed, or write the review simply by photographing the information code without a cumbersome procedure of starting the application program, keying in log-in information, checking ordering information, and choosing the order.

Referring to FIG. 8, the user of the device 100 may photograph the actually delivered item after opening the package of the delivered item in addition to starting the application program and photographing the information code (S800). The device 100 or the service server 200 may extract the delivered item from the image of the actually delivered item by applying the image analysis program, and compare the extracted delivered item information with the product information in the ordering information corresponding to the information code to determine whether the ordered item has been delivered properly (S802).

If the delivered item is identical to the ordered item, the order-related service notification window from the service server 200 may be output through the display unit 160 of the device 100 as described above with reference to FIG. 6 (S804). However, if the delivered item is different from the ordered item, the notification window querying whether to return or exchange the delivered item or confirm purchase completion may be output through the display unit 160 of the device 100 (S806).

Here, in case that the authentication process shows that the user of the device 100 is the orderer, the order-related service notification window may include the service options of the purchase completion, the return request, and the exchange request. Contrarily, in case that the user of the device 100 is a separate recipient designated by the orderer, the notification window may include the service options of the receipt confirmation and the exchange request while the return request which may require personal information such as payment information may be excluded from the service options.

If the user requests a desired service through the order-related service notification window or the notification window querying the exchange or return (S808), the service server 200 may provide the device 100 with the service page corresponding to the service request (S810).

The details of the order-related service notification window are similar to those described above with reference to FIG. 6.

Meanwhile, if the user of the device 100, who is also the recipient and orderer, chooses the return or exchange request in the notification window querying the exchange or return, the service server 200 may provide the device 100 with the return request page or the exchange request page correspondingly to the service request from the device 100. If the user wishes to complete the purchase of the delivery item even though the delivered item is different from the ordered item, the user may choose the purchase completion option, so that the service server 200 may change the status of the order into the ‘purchase-completed’ state. On the other hand, if the user of the device 100, who is not the orderer but the recipient designated by the orderer, chooses the exchange request, the service server 200 may provide the device 100 with the exchange request page. If the user of the device 100, who is the recipient designated by the orderer, wishes to confirm the receipt of the delivery item even though the delivered item is different from the ordered item, the user may choose the receipt confirmation option, so that the service server 200 may change the status of the order into the ‘receipt-confirmed’ state. The service server 200 may notify the receipt confirmation of the recipient to the orderer by the short message service (SMS), e-mail, instant messenger, or the like.

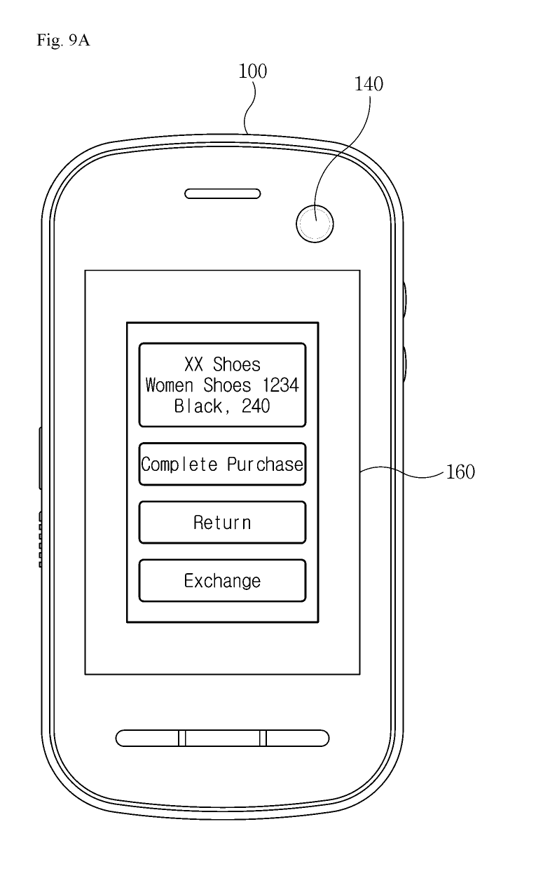

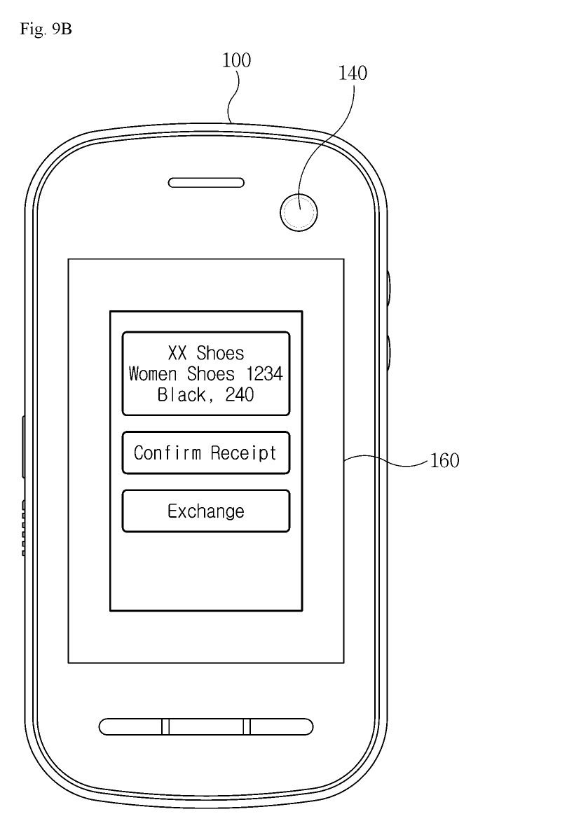

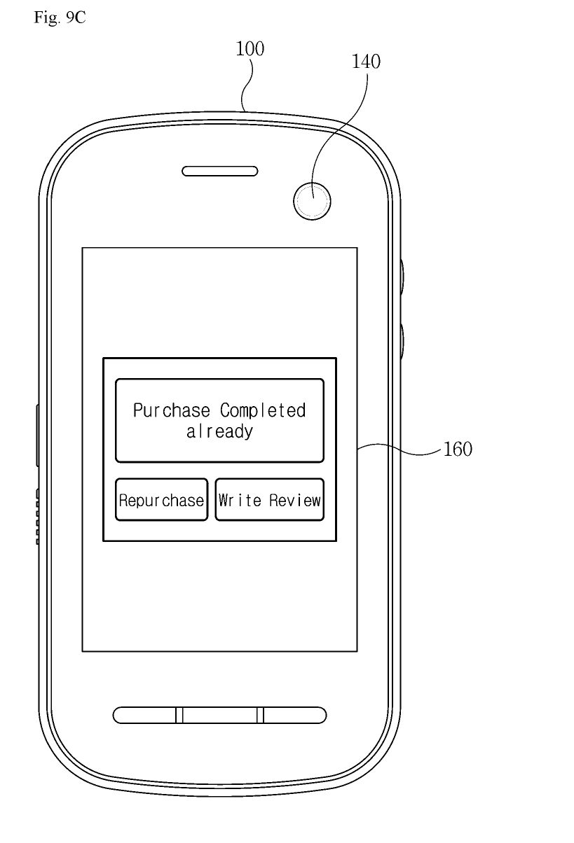

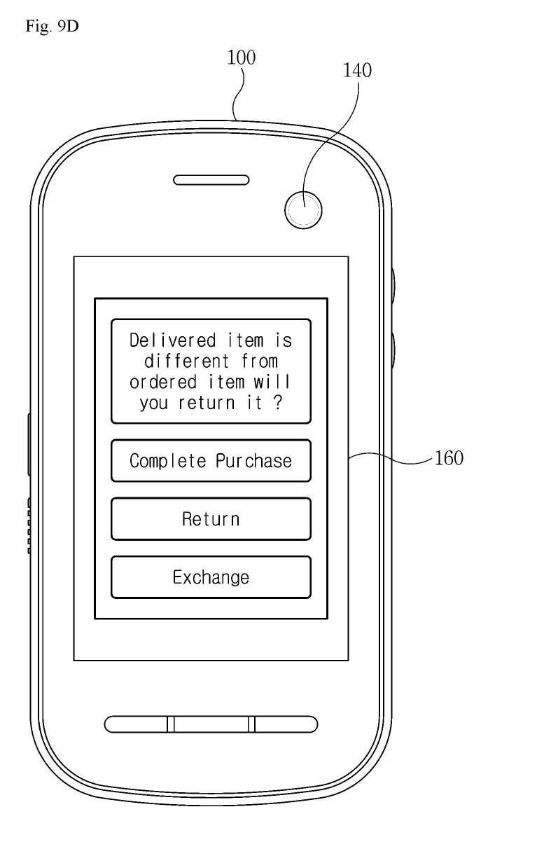

FIGS. 9A through 9D are exemplary screenshots provided according to the recognition of the information code in the electronic commerce method using the information code according to an embodiment of the present disclosure.

FIG. 9A is an exemplary screenshot of the order-related service notification window displayed on the display unit 160 of the device 100 in case where the user of the device 100, who is the recipient, is also the order. The order-related service notification window is constructed based on the information code attached on the package of the delivery item and photographed by the user of the device 100 using the camera unit 140.

The ordering information such as product information including a product name (e.g., women shoes), a brand name (e.g., XX shoes), and other options (e.g., color: black, size: 240) may be acquired from the service server 200 based on the information code to be displayed in the order-related service notification window. Also, the service options such as ‘COMPLETE PURCHASE,’ RETURN,′ and ‘EXCHANGE’ may be included in the order-related service notification window so as to enable the user choose one of the service options.

FIG. 9B is an exemplary screenshot of the order-related service notification window displayed on the display unit 160 of the device 100 in case where the user of the device 100 is different from the orderer but is the recipient designated by the orderer. The order-related service notification window is constructed based on the information code also in this case.

The ordering may be acquired from the service server 200 based on the information code to be displayed in the order-related service notification window. Also, the service options such as ‘CONFIRM RECEIPT’ and ‘EXCHANGE’ may be included in the order-related service notification window so as to enable the user choose one of the service options.

FIG. 9C is an exemplary screenshot of the order-related service notification window displayed on the display unit 160 of the device 100 in case where the current status of the order of the delivery item corresponding to the information code shows the purchase-completed state.

In case that the user of the device 100, who is also the recipient and orderer, already has confirmed the purchase completion of the delivery item, the order-related service notification window may include the service options of ‘REPURCHASE’ and ‘WRITE REVIEW.’ The ‘REPURCHASE’ option allows the recipient to easily repurchase the item. The ‘WRITE REVIEW’ option allows the recipient to leave a review and rate a recommendation index for the delivery item. If the user chooses the ‘REPURCHASE’ option, the payment page may be displayed on the display unit 160. If the user chooses the ‘WRITE REVIEW’ option, the page for writing and submitting the review of the product may be displayed on the display unit 160

On the other hand, in case where the user of the device 100, who is not the orderer but the recipient designated by the orderer, has already confirmed the receipt of the delivery item, when the user chooses the ‘REPURCHASE’ option, the ordering page including the product information and the seller information may be provided to the device 100.

FIG. 9D is an exemplary screenshot of the notification window displayed on the display unit 160 of the device 100 in case where the actually delivered item is different from the ordered item. In this case, the notification window may include the service options of ‘CONFIRM RECEIPT,’ ‘RETURN,’ and ‘EXCHANGE.’

In case that the user of the device 100 who is the recipient of the item is also the orderer, when the actually delivered item which is identified by an image analysis of the image of the delivered item is different from the ordered item in the ordering information identified by the information code, the notification window may include the service options of the ‘RETURN’ and ‘EXCHANGE’ to allow the user to simply request the return and exchange, respectively, of the delivered item. Also, the ‘COMPLETE PURCHASE’ option may be added to the service options because the user may be reluctant to return or exchange the delivery item even though the delivered item is different from the ordered item.

If the user of the device 100 chooses the ‘COMPLETE PURCHASE’ option, the service server 200 receiving the service request may change the status of the order into a ‘purchase completed’ state. If the user of the device 100 chooses the ‘RETURN’ or ‘EXCHANGE’ options in the notification window, the service server 200 may provide the device 100 with the page for requesting the return or exchange of the delivered item so that the user may easily request the return or exchange of the delivered item.

Meanwhile, if the user of the device 100 is the recipient designated by the orderer, the notification window including the service options of the ‘CONFIRM RECEIPT’ and ‘EXCHANGE’ may be provided to the device 100.

The screenshots shown in FIGS. 9A through 9D are provided for exemplary purposes and the present disclosure is not limited thereto. For example, the information of the delivery item corresponding to the information code may be output in an augmented reality form.

In other words, the image of the delivery item provided by the service server 200 may be output in the augmented reality in combination with the order-related service notification window including the ordering information, the notification window querying whether to write a review of the product, or the notification window querying whether to return the item.

Also, the image of the actually delivered item photographed in a state that the package is opened may be output in the augmented reality in combination with the notification window querying whether to return the delivered item.

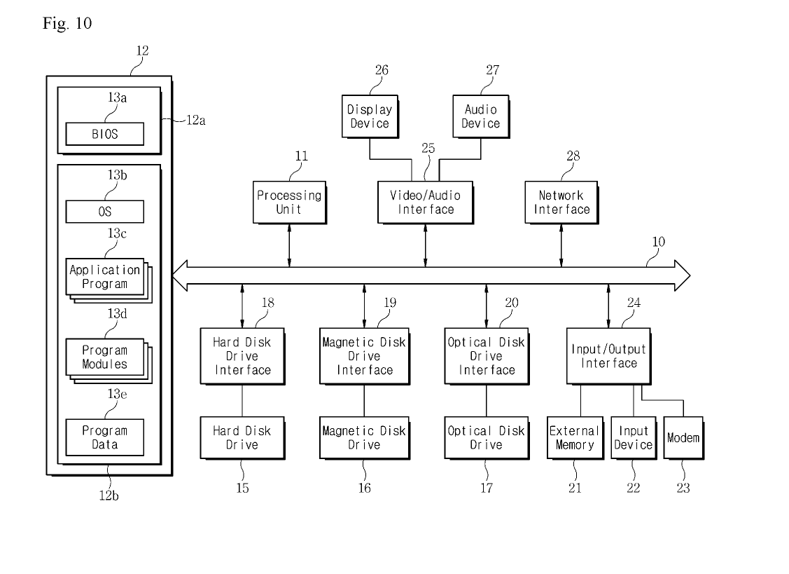

FIG. 10 is a block diagram illustrating an operating environment of a service server or a device for implementing an electronic commerce method using an information code according to an embodiment of the present disclosure.

FIG. 10 and the following description are intended to provide a brief and general description of a suitable computing environment in which the present disclosure may be implemented. Although it is not required, the present disclosure may be described in connection with computer-executable instructions such as program modules that may be executed by a computer system.

Generally, the program modules include routines, programs, objects, components, data structures, and so on suitable for performing particular tasks or implementing particular abstract data types. The computer-executable instructions, associated data structures, and program modules exemplify the program code means for carrying out processes described herein.

Referring to FIG. 10, an exemplary computing system suitable for implementing the present disclosure may include a processing unit 11, a system memory 12, and a system bus 10 that connects various system components including the system memory 12 to the processing unit 11.

The processing unit 11 is capable of executing computer-executable instructions designed to implement the features of the present disclosure.

The system bus 10 may be any of several types of bus architectures including a local bus, an external bus, and a memory bus. Alternatively, the system bus 10 may be any of the bus architectures employing a memory controller.

The system memory 12 includes a read-only memory (ROM) 12A and a random access memory 12B. A Basic Input/Output System (BIOS) 13A which includes basic routines that help information transfer between components within the computing system when the system is booted may generally be stored in the ROM 12A.

The computing system may include storage devices. For example, the computing system may include a hard disk drive 15 that reads information from or writes information to a hard disk, a magnetic disk drive 16 that reads information from or writes information to a magnetic disk, and an optical disk drive 17 that reads information from or writes information to an optical disk such as a CD-ROM and other optical medium. The hard disk drive 15, the magnetic disk drive 16, and the optical disk drive 17 may be connected to the system bus 10 by a hard disk drive interface 18, a magnetic disk drive interface 19, and an optical drive interface 20, respectively.

Also, the computing system may further include an external memory 21 as one kind of the storage device. The external memory 21 may be connected to the system bus 10 through an input/output (I/O) interface 24.

The above-described drives and the computer-readable media that may be accessed by the drives allows nonvolatile storage of computer-executable instructions, data structures, program modules, and other data.

The exemplary environment described herein illustrates the hard disk 15, the magnetic disk 16, and the optical disk 17, but other types of computer-readable media for storing data such as a magnetic cassette, a flash memory card, a DVD, a Bernoulli cartridge, a RAM, and a ROM may be used as well.

The program code means including one or more program modules that may be loaded and executed by the processing unit 11 and includes an operating system 13B, one or more application programs 13C, other program modules 13D, and program data 13E may be stored in the hard disk 15, the magnetic disk 16, the optical disk 17, the ROM 12A or the RAM 12B.

Also, the computing system may receive commands and information from a user through input devices 22 such as a keyboard, a pointing device, a microphone, a joystick, a game pad, and a scanner. These input devices 22 may be connected to the processing unit 11 via the I/O interface 24 connected to the system bus 10. The I/O interface 24 may logically represent at least one or a combinations of various interfaces such as, for example, a serial port interface, a PS/2 interface, a parallel port interface, a USB interface, an Institute of Electrical and Electronics Engineers (IEEE) 1394 interface (i.e., FireWire interface), and other interfaces.

In addition, the computing system may further include a display device 26 such as a monitor and a liquid crystal display (LCD), and an audio device 27 such as a speaker and a microphone. The display device 26 and the audio device 27 may be connected to the system bus 10 through a video/audio interface 25. Other peripheral devices (not shown) such as a speaker and a printer, for example, may be connected to the computing system. The video/audio interface 25 may include a High Definition Multimedia Interface (HDMI) and Graphics Device Interface (GDI).

The computing system may be connected to a network such as, for example, an office wide area network (WAN) or an enterprise WAN, a home network, Intranet, and/or Internet. The computing system may exchange data with external sources such as, for example, a remote computer system, a remote application, and/or a remote database.

To this end, the computing system may include a network interface 28 for receiving data from an external source and/or transmitting data to the external source.

The computing system may transmit and receive information to and from a remote device through the network interface 28.

For example, in case that the computing system refers to the first beacon device 200, the computing system may communicate with the service device 400 through the network interface 28. On the other hand, in case that the computing system refers to the service device 400, the computing system may exchanged information with the first beacon device 200 through the network interface 28. The network interface 28 may represent a network interface card, or an equivalent software such as a network driver interface specification (NDIS) stack, an equivalent hardware, and/or a logical combination of the software and hardware.

Likewise, the computing system may transmit and receive data to and from an external source through the I/O interface 24. The I/O interface 24 may be connected to a modem 23 such as a standard modem, a cable modem, and a digital subscriber line (DSL) modem. The computing system may transmit and receive data to and from the external source through the modem 23.

Although FIG. 10 shows an operating environment suitable for the present disclosure, the principles of the present disclosure may be applicable to any other system capable of implementing the principles of the present disclosure with an appropriate modifications, if necessary. The environment shown in FIG. 10 is illustrative only and does not represent even a small portion of various environments in which the principles of the present disclosure may be implemented.

In addition, various information generated during the execution of the program according to the present disclosure may be stored and accessed in a computer-readable medium related with the computing system. For example, a portion of these program modules and a portion of the associated program data may be included in the operating system 13B, the application program 13C, the program module 13D, and/or the program data 13E to be stored in the system memory 12.

Further, when a mass storage device such as the hard disk is connected to the computing system, such program module and related program data may be stored in the mass storage device.

In a networked environment, the program modules associated with the present disclosure, or portions thereof, may be stored in a remote computer system (e.g. a system memory related with a computing system of the first beacon device 100 and the service device 400, or a remote memory device such as a mass storage device) connected via the I/O interface 24 and the modem 23 or the network interface 25. The execution of such a module may be performed in a distributed environment as described above.

The process steps or operations may be performed by one or more programmable processors executing computer programs to perform functions by operating on input data to yield an output. The process steps or operations and hardware elements may also be performed by special purpose logic circuitry, e.g., a field programmable gate array (FPGA) or an application-specific integrated circuit (ASIC).

Processors suitable for processing computer programs may include, for example, both of or any one of general purpose and special purpose microprocessors. Generally, the processor will receive instructions and data from the ROM, the RAM, or both of them. The elements of the computer may include at least one processor for executing instructions and one or more memory devices for storing instructions and data.

In general, a computer may include one or more mass storage devices, e.g., a magneto-optical disk, or an optical disk, or may receive and transmit data from and to such devices.

The information carriers suitable for storing the computer program instructions and data may include, for example, magnetic media such as a hard disk, a floppy disk, and a magnetic tape, optical media such as a compact disk read only memory (CD-ROM) and a digital video disk (DVD), magneto-optical medium such as a floptical disk, and semiconductor memories such as the ROM, the RAM, the flash memory, erasable and programmable ROM (EPROM), and electrically erasable and programmable ROM (EEPROM).

The processor and memory may be supplemented by or integrated with special purpose logic circuits.

While the present specification contains a number of specific implementation details, it should be understood that they are not to be construed as limitations on the scope of any disclosure or claims, but as a description of features that may be specific to a particular embodiment of a particular disclosure.

Certain features described with respect to contexts of independent embodiments may be implemented in combination in a single embodiment. Conversely, various features described in the context of a single embodiment may also be implemented in other embodiments either individually or in any suitable sub-combination.

Further, although some features may be described to operate in a particular combination and may be initially depicted as so claimed, one or more features from the claimed combination may in some cases be excluded from the combination, and a claimed combination may be replaced by a sub-combination or a variant of the sub-combination.

Similarly, although the operations are depicted in the drawings in a particular order, it should not be understood that such operations need to be performed in that particular order or sequential order shown to achieve the desired result or all the depicted operations should be performed.

In certain cases, multitasking and parallel processing may be advantageous. Also, The fragmentation of the various system components in the above-described embodiments should not be understood as requiring such fragmentation in all embodiments, and the program components and systems described above may generally be integrated together into a single software product or packaged into a multiple-function software product.

Though specific embodiments of the subject matter described herein have been described above, it should be noted that other embodiments are within the scope of the following claims.

For example, the operations recited in the claims may be performed in a different order to achieve the desired result. As an example, the process illustrated in the accompanying drawings does not necessarily require that particularly illustrated order or sequential order to obtain the desired result.

The descriptions set forth above disclose the best mode of the present disclosure, and is provided to illustrate the disclosure and to enable those skilled in the art to make and use the disclosure. The written description is not intended to limit the disclosure to the specific terminology presented. Thus, although the present disclosure has been described in detail with reference to the above examples, those skilled in the art will be able to make adaptations, modifications, and variations on the examples without departing from the scope of the present disclosure.

What is claimed is:

1. A method of conducting electronic commerce by use of an information code in a service server accessible by a device through a communication network, the method comprising:
identifying the information code for a delivery item captured by the device;
decoding the identified information code;
acquiring order information of the delivery item corresponding to the decoded information code;
providing an order-related service notification window including the order information of the delivery item to the device through an application program executed in the device;
receiving a service request for the delivery item through the order-related service notification window; and
providing a service page corresponding to the service request.

2. The method of claim 1, wherein the method further comprises:
collecting authentication base information of the device to authenticate whether a user of the device is a legitimate recipient of the delivery item;
authenticating the user by comparing the authentication base information of the device with orderer information and recipient information, wherein the recipient information is received from an orderer when the orderer orders the delivery item; and
when the user is authenticated, providing the order-related service notification window to the device.

3. The method of claim 2, wherein, when the authentication base information of the device corresponds to the orderer information and the recipient information, and the user of the device is authenticated, the method comprises:
providing, through the order-related service notification window, at least one of service options to select by the user, wherein the service options comprise a purchase completion, a return request, and an exchange request for the delivery item; and
receiving, through the application program, the selected service option.

4. The method of claim 2, wherein, when the authentication base information of the device corresponds to the recipient information, and the user of the device is authenticated, the method further comprises:
providing, through the order-related service notification window, at least one of the service options to select by the user; and
receiving, through the application program, the selected service option.

5. The method of claim 1, wherein the method further comprises:
checking a current status of an order of the delivery item corresponding to the decoded information code; and
when the current status of the order is a purchase-completed state or a receipt-confirmed state, providing an alert window to the device, wherein the alert window queries whether to repurchase the delivery item or write a review regarding the delivery item.

6. The method of claim 1, wherein the method further comprises:
receiving an actual image of the delivery item captured by the device;
determining whether the delivery item corresponds to the order information by comparing the actual image of the delivery item with the order information for the delivery item corresponding to the decoded information code; and
when it is determined that the delivery item does not correspond to the order information, querying whether to return or exchange the delivery item through a notification window in the application program.

7. A method of conducting electronic commerce by use of an information code in a device capable of accessing a service server through a communication network, comprising:
when an application program is executed, capturing and decoding the information code for a delivery item;
acquiring order information of the delivery item corresponding to the decoded information code;
authenticating whether a user of the device is a legitimate recipient of the delivery item by comparing authentication base information of the device with orderer information and recipient information;
when the user of the device is authenticated, displaying an order-related service notification window including the order information of the delivery item corresponding to the decoded information through the application program;
receiving a service request for the delivery item through the order-related service notification window; and
displaying a service page corresponding to the service request.

8. The method of claim 7, wherein the method further comprises:
capturing the delivery item;
determining whether the delivery item corresponds to the order information by comparing an image of the captured delivery item with the order information for the delivery item; and
when it is determined that the delivery item does not correspond to the order information, displaying a notification window to query whether to return or exchange the delivery item through the application program.

9. A service server system for providing electronic commerce service by use of an information code, comprising:
a service communicator configured to transmit and receive data to and from a device through a communication network; and
a service controller configured to:
decode the information code for a delivery item captured by the device to acquire order information of the delivery item;
provide an order-related service notification window including the order information of the delivery item to the device;
receive a service request for the delivery item through the order-related service notification window; and
provide a service page corresponding to the service request for the delivery item through the order-related service notification window.

10. The system of claim 9, wherein the service controller is configured to:
collect authentication base information of the device to authenticate whether a user of the device is a legitimate recipient of the delivery item; and
authenticate the user by comparing the authentication base information of the device with orderer information and recipient information to provide the order-related service notification window to the device when the user is authenticated, wherein the recipient information is received from an orderer when the orderer orders the delivery item.

11. The system of claim 10, wherein, when the authentication base information of the device corresponds to the orderer information and the recipient information, and the user of the device is authenticated, the service controller is configured to:
provide at least one of service options to select by the user through the order-related service notification window, wherein the service options comprise a purchase completion, a receipt confirmation, a return request and an exchange request for the delivery item; and
receive the selected service option through the device.

12. The system of claim 10, wherein, when the authentication base information of the device corresponds to the recipient information, and the user of the device is authenticated, the service controller is further configured to:
provide, to the device, the order-related service notification window including at least one of the service options to select by the user; and
receive the selected service option through the device.

13. The system of claim 9, wherein the service controller is further configured to:
check a current status of an order of the delivery item corresponding to the decoded information code; and
when the current status of the order is a purchase-completed state or a receipt-confirmed state, provide an alert window to the device, wherein the alert window queries whether to repurchase the delivery item or write a review regarding the delivery item.

14. The system of claim 10, wherein the service controller is further configured to:
compare an actual image of the delivery item with the order information for the delivery item corresponding to the decoded information code;
determine whether the delivery item corresponds to the order information; and
when it is determined that the delivery item does not correspond to the order information, query whether to return or exchange the delivery item through the device.
